(19) United States
(12) Patent Application Publication
(10) Pub. No.: US 2026/0278528 A1
(43) Pub. Date: Sep. 17, 2026

(54) Touchless Processing System of Packages for Delivery and/or Pickup through Wireless Integration on a Storage System and Method for the Same.

(71) Applicants: Torrey M Bievenour, Indianapolis, IN (US); Keith Russell, Indianapolis, IN (US); Rob Johnson, Fishers, IN (US); Ton McCampbell, Hawthorne, CA (US)

(72) Inventors: Torrey M Bievenour, Indianapolis, IN (US); Keith Russell, Indianapolis, IN (US); Rob Johnson, Fishers, IN (US); Ton McCampbell, Hawthorne, CA (US)

(21) Appl. No.: 19/569,928

(22) Filed: Mar. 17, 2026

Related U.S. Application Data
(60) Provisional application No. 63/773,187, filed on Mar. 17, 2025.

(51) Int. Cl. G06Q 10/0836; G06K 7/10

(52) U.S. Cl. CPC G06Q 10/08365; G06K 7/10366

(57) ABSTRACT

A touchless RFID-based package processing system and method integrates multi-range antennas, package RFID tags, cloud synchronization, and AI logic within a modular locker bank. The system automatically authenticates carriers (drones, AMRs, couriers), selects and opens the correct compartment, confirms placement or removal via compartment antennas, maintains an unbroken chain-of-custody record, and notifies recipients-all without physical contact or manual scanning. Outbound shipping and returns are fully integrated. The invention eliminates porch piracy, reduces mis-deliveries, and provides 24/7 secure multi-user access for residential and commercial environments.

### CROSS-REFERENCE TO RELATED APPLICATIONS

This application claims the benefit of United States Provisional Patent Application with Ser. No. 63/773,187 filed Mar. 17, 2025, by Torrey M. Bievenour et al and entitled “A Touchless Processing System of Packages for Delivery and/or Pickup through Wireless Integration on a Storage System and Method for the Same”.

### FIELD OF INVENTION

This invention relates to a Touchless Processing of Packages for Delivery and/or Pickup through Wireless Integration on a Storage System. This is a receiving and shipping system and/process/method for an autonomous mobile robot (quadra-pods, automated guided vehicles, ground-based pods, articulated robots, bipods, cobots, humanoids, etc.), drones, and/or courier systems to deliver, hold, protect, and return parcels for multi-users in both residential and commercial applications. This is a system and process interlinking a receiving and shipping, smart receptacles with a communication system including package identifiers that enable a process to communicate location, contents, shipper, receiver and timing between the sender and receiver of the packages/parcels. The invention relates to drones, couriers, and/or autonomous mobile robots (AMR) for the delivery of parcels or goods. The present application relates to a process with a delivery location for receiving a package from a vehicle—drone or unmanned aerial vehicle (UAV), robotic carriers/couriers, or automated unmanned vehicle systems (AUVS) and AMRs. The present disclosure relates to communication and tracking system.

The embodiments of the disclosure relate to the field of aircraft and unmanned vehicular delivery, to a device for receiving and sending an article, parcel and/or package. A smart receptacle device and system for a docking station to address for deposit of items delivered by drone, robot or AUVs/AMRs. Items may include but not be limited to multi-use parcels, food items, groceries, repair parts, drugs and pharmaceutical packages. Placed in a secure building, porch, roof, window or otherwise building mounted box may be secured through to an existing edifice or may be configured to mount to an existing location to replicate shipping and receiving locations, and to replace current locker box systems and/or take the place of the multi-use, secure mailbox. The invention relates to drones, couriers, and autonomous mobile robots (AMRs) for delivery and return of parcels and/or goods.

### FEDERALLY SPONSORED RESEARCH

None.

### SEQUENCE LISTING OR PROGRAM

None.

### BACKGROUND-FIELD OF INVENTION AND PRIOR ART

As far as known, there are no devices and/or systems to like this Touchless Processing System of Packages for Delivery and/or Pickup through Wireless Integration on a Storage System and Method for the Same. It is believed that this product is unique in its design and technologies. A background as to deliveries and the current industry and market should be useful. Unmanned aerial vehicles (UAVs) comprise a variety of vehicles, from conventional fixed wing airplanes, to helicopters, to ornithopters (i.e., machines that fly like birds), and are used in a variety of roles. They (delivery or return/pick-up devices and can be remotely piloted by a pilot on the ground or can be autonomous or semi-autonomous vehicles that make unmanned ground deliveries or fly missions using preprogrammed coordinates, GPS navigation, etc. UAVs/AMRs can include remote-controlled helicopters and airplanes for the hobbyist, for example. UAVs/AMRs may be equipped with cameras to provide imagery during flight or traversing sidewalks, roads, or grounds, which may be used for navigational or other purposes, e.g., identify a house or commercial address, etc. Unmanned Aerial Vehicles (UAVs) and Autonomous Mobile Robots (AMRs) can also be equipped with sensors to provide local weather and atmospheric conditions, radiation levels, and other conditions. UAVs/AMRs may also include cargo bays, hooks, or other means for carrying payloads. Newer generation UAVs/AMRs may also provide significant payload capabilities. As a result, UAVs/AMRs can also be used for delivering packages, groceries, mail, and other items. The use of UAVs/AMRs for deliveries can reduce costs and increase speed and accuracy. The range provided by current UAVs/AMRs technology, however, makes deliveries over a wide area—e.g., throughout a city, or even a portion of a city-difficult.

Parcel transportation between an origin and a destination is traditionally a labor-intensive process. For short distances, “local” deliveries, an item (e.g., parcel) may be transported by a delivery person between the origin and the destination. For example, the delivery person/courier may drive a vehicle to transport the item between the origin and the destination and may ensure that the item is properly picked up and/or delivered according to specific delivery instructions required. For longer-distance deliveries, transportation of an item may involve several delivery methods and personnel, who may individually perform one or more steps for picking up an item, sorting the item one or more times, transporting the item from a final sort of location to a final delivery destination, and/or delivering the item from the delivery vehicle to the destination address (e.g., serviceable point). Because of the labor-intensive nature of this process, various attempts have been made to assist carrier personnel by reducing the physical demands required in the transportation and delivery process. However, prior attempts have faced substantial difficulties in ensuring that various aspects of the transportation and delivery process are properly performed. For example, attempts have been made to utilize unmanned vehicles, such as Unmanned Aerial Vehicles (UAVs) and AMRs to transport items from a final sorting location to an intended final delivery destination. However, such concepts are generally limited by the effective range of the UAVs/AMRs, as well as the number of available UAVs/AMRs that may be utilized to deliver items to locations a substantial distance away from the final sort of location. Accordingly, a need exists for additional systems and methods to assist carrier/courier personnel and thereby reduce the physical demands of the transportation and delivery process.

Typically ordered items are packed in shipping packages (e.g., corrugated cardboard boxes or plastic bags and sacks) and shipped to the user's residence or place of business. Physical delivery of items to user specified locations has improved dramatically over the years, with some aggressive retailers offering next day delivery of ordered items. The final or last mile delivery of physical items to a user specified location is traditionally accomplished using a human controlled truck, bicycle, cart, etc. For example, a user may order an item for delivery to their home. The item may be picked from a ground-based material handling facility, packed, and shipped to the user for final delivery by a shipping carrier. The shipping carrier will load the item onto a truck that is driven by a human to the final delivery location and the human driver, or another human companion with the driver, will retrieve the item from the truck and complete the delivery to the destination. For example, the human may hand the item to a recipient, place the item on the user's porch, store the item in a post office box, etc. In these new times where the world is changing before one's very eyes, technology must keep up with consumer habits. Efficiency, cost savings, technology, convenience, ease, safety, and more combine to dictate where the US and world market economy is going.

One emerging sector of the economy is last mile logistics. Within this segment of the shipping economy is a rapidly developing facet known as drone delivery. Shifting metrics in the world's ecosystem dictate now, more than ever, the need for autonomous delivery. Enter ARRIVE AI for interacting with AMRs, drones, and AUVs delivering to multi-user locations. Every day in the US more than 1.7 million packages are stolen. The loss created is in the billions. Arrive AI smart locker boxes and units at multi users helps solve this problem through encrypted, authenticated delivery. Every day in the US, thousands of packages are mis-shipped. ARRIVE AI solves this problem through encrypted, authenticated delivery using RFID, or Radio-Frequency Identification. This is a technology that uses radio waves to identify and track objects wirelessly, in a similar manner as barcodes, but without requiring a line of sight. Arrive AI smart locker with secure receptacle/boxes allow shippers, deliverers, and recipients to increase efficiency while maintaining the chain of custody of the package/parcel.

At its core, this invention and perfection of smart receiving and shipping centers, introduced by AI-powered Arrive Points, serves as smart receiving and shipping centers and ensures that package deliveries are safe, organized, and accessible 24/7. Arrive AI's “A” Project for a large residential area in Florida is a pilot program designed to enhance secure and convenient package management for residents. At its core, the project introduces AI-powered Arrive Points, which serve as smart receiving and shipping centers, ensuring that deliveries are safe, organized, and accessible 24/7. These hubs act as intelligent package lockers, providing residents with a seamless way to receive and send out deliveries without the need to be home. Equipped with advanced RFID sensors, the system does more than just scan labels—it actively senses packages as couriers deliver them. The AI-powered hub gauges package size and directs couriers to the correct compartment, ensuring efficient space utilization. It then provides instant confirmation that the correct package has been secured in the right container, enhancing security and eliminating delivery errors. For residents shipping packages, the system includes an RFID printer, allowing them to simply bring a package to the hub and print its shipping label-no hassle, no fuss. This streamlined process makes sending out packages as easy as receiving them. By integrating advanced tracking, secure storage, and climate assist technology, the Arrive AI's “A” Project aims to eliminate porch piracy, reduce missed deliveries, and simplify shipping needs for an active senior community.

### Problem Solved

The improvement and problem solved as a system for a commercial or residential application serving multiple recipients/multi-users of packages. In addition, the system provides direct communication with the parcels since they have RFID tags which contain the information as to the contents, location, various demographics. At a high level, RFID antennas coupled with RFID tags on packages allow establishing a Chain of Custody on packages inferring intent and actions of package handlers (couriers, recipients, etc.). These locker banks with antennas, screens, keypad, and connections with the RFID components such as: A. RFID Antennas for Area, Mid and long-range connectivity; B. RFID Antenna for presenting Short Range; C. RFID Antenna for compartments, short range; and RFID Tags on a package or RFID badge for identification on a person.

### PRIOR ART

As far as known, there are no Touchless Processing System of Packages for Delivery and/or Pickup through Wireless Integration on a Storage System and Method for the Same. A novelty search revealed no concerns with prior are posing a section 102 or 103 rejection of this new technology for improving the shipping and receiving systems for parcels in the last inch of the last mile and the chain of custody for each package.

### SUMMARY OF THE INVENTION

This invention is a Touchless Processing System of Packages for Delivery and/or Pickup through Wireless Integration on a Storage System and Method for the Same. At a high level, RFID antennas coupled with RFID tags on packages allow establishing a Chain of Custody on packages inferring intent and actions of package handlers (couriers, recipients, etc.). A locker bank with antennas, screens, keypad, and connections with the RFID components such as:
A. RFID Antennas for Area, Mid and long-range connectivity
B. RFID Antenna for presenting Short Range
C. RFID Antenna for compartments, short range
D. RFID Tags on a package or RFID badge for identification on a person.

### OBJECTS AND ADVANTAGES

There are several objects and advantages of A Touchless Processing System of Packages for Delivery and/or Pickup through Wireless Integration on a Storage System and Method for the Same. There are currently no known smart locker boxes that achieve the 24/7 chain of custody for shipping and receiving packages from unmanned aerial vehicle (UAV), robotic carriers—autonomous mobile robots (AMRs) or automated unmanned vehicle systems (AUVS), drones, and/or couriers that are effective at providing the objects of this invention. The various advantages and benefits are shown in the descriptions below.

Finally, other advantages and additional features of the new and unique system to Deliver, Hold, Protect, and Receive Parcels for multi-users in residential and Commercial applications will be more apparent from the accompanying drawings and from the full description of the system.

### DESCRIPTION OF THE DRAWINGS—FIGURES

The accompanying drawings, which are incorporated in and constitute a part of this specification, illustrate an embodiment of a system with a Touchless Processing System of Packages for Delivery and/or Pickup through Wireless Integration on a Storage System and Method for the Same. The drawings together with the summary description given above and a detailed description given below explain the principles of the device and system. It is understood, however, that the system and processes are not limited to only the precise arrangements and instrumentalities shown.

FIGS. 1A through 1D are sketches of a Touchless Processing System of Packages for Delivery and/or Pickup through Wireless Integration on a Storage System and Method for the Same, an overview/review of a real time RFID Smart Locker box used for Postal companies that make use of RFID Labels, a flowchart and discussion of the systems architecture, and sketches of a prototype of the Touchless Processing System of Packages for Delivery and/or Pickup through Wireless Integration on a Storage System.

FIG. 2 is a working sketch of the Touchless Processing System of Packages for Delivery and/or Pickup through Wireless Integration on a Storage System.

FIGS. 3A through 3D are views of a real time RFID Smart Locker box used for Postal companies that make use of RFID Labels.

FIGS. 4, 4A and 4B are flowchart sketches of the communication architecture of the Touchless Processing System of Packages for Delivery and/or Pickup through Wireless Integration on a Storage System.

FIGS. 5A through 5Z are the operation of aa prototype system of the Touchless Processing System of Packages for Delivery and/or Pickup through Wireless Integration on a Storage System.

### DESCRIPTION OF THE DRAWINGS—REFERENCE NUMERALS

The following list refers to the drawings:

TABLE B
Reference numbers

| Ref # | Description |
|---|---|
| 30 | Touchless Processing System 30 of Packages for Delivery and/or |
| | Pickup through Wireless Integration on a Storage System and |
| | Method for the Same |
| 31 | sketches of a prototype locker bank 31 of the Touchless |
| | Processing System of Packages for Delivery and/or Pickup |
| | through Wireless Integration on a Storage System 30 |
| 40 | components for the locker bank 31 and prototype |
| 41 | RFID Antennas 41 for Area, Mid/Long Range |
| 42 | RFID Antenna 42 for Presenting, Short Range |
| 43 | RFID Antennas 43 for Compartments, Short Range |
| 44 | RFID Tag 44, Package 150 |
| 45 | RFID Badge 45, Person 100 |
| 50 | a flowchart 50 and discussion of the systems architecture |
| 51 | flow chart feature 51 - Kiosk hardware Screen, Microphone, |
| | Speaker, Barcode Reader, and Camera Communications |
| 52 | flow chart feature 52 Key Functionality SW to Hardware, Read |
| | RFID, Read Barcode |
| 53 | flow chart feature 53 Key Functionality - Kiosk to Cloud- - |
| | notify of Outbound Shipment, Request Package Compartment |
| | for Outbound, Events include Request Package Data and |
| | Request Locker Door Open |
| 54 | flow chart feature 54 Key Functionality - Cloud to Kiosk- - |
| | Notify of Inbound Shipment, ACL Management, Share Locker |
| | Reservations List |
| 55 | flow chart feature 55 Key Functionality - Direction |
| | Package Delivery Plan (to Arrive) and Package Size |
| | Validations (UPS) |
| 56 | flow chart feature 56 Key Functionality - Locker to Cloud - - |
| | Status Updates (Health, Doors, Compartments) and Events |
| | (Door Open/Close, Compartment Change) |
| 57 | flow chart feature 57 Key Functionality - Cloud to Locker - - |
| | Open Each Locker, Read Open/ Closed Status for Each Locker, |
| | Get List of Lockers, Get Logs, (Open all Lockers) and |
| | (Operational Status) |
| 58 | flow chart feature 58 Key Functionality - DB to Middleware |
| | Change Events |
| 59 | flow chart feature 59 Key Functionality - Middleware to |
| | Backend - - DB Updates, DB Reads, Atomic Locker Actions |
| 59A | flow chart feature 59A Key Functionality - Business Logic -- |
| | Compartment Reservations, Compartment Access, and |
| | Notifications |
| 60 | sketches of steps 60 in a Touchless Processing System 30 of |
| | Packages for Delivery and/or Pickup through Wireless |
| | Integration on a Storage System and Method for the Same |
| 70 | features 70 Touchless Processing System 30 of Packages for |
| | Delivery and/or Pickup through Wireless Integration on a |
| | Storage System and Method for the Same |
| 71 | feature 71 UPS data Base sends out a delivery request, synchs |
| | mail info for Arrive Points |
| 72 | feature 72 Arrive Cloud server receives request from UPS and |
| | the Arrive locker 31 |
| 73 | feature 73 UHF RFID reader picks up/ receives incoming |
| | packages 150 IDs |
| 74 | feature 74 Kiosk can be external or embedded in the smart box/ |
| | locker 31 |
| 75 | feature 75 scale for packages 150 to be shipped |
| 76 | feature 76 smart locker box 76, 31 with real time UHF RFID |
| | Readers scanning for Package 150 arrival keeps up with assets |
| 100 | Person 100 |
| 150 | Package 150 |

### DETAILED DESCRIPTION OF PREFERRED EMBODIMENT

This invention relates to a Touchless Processing of Packages for Delivery and/or Pickup through Wireless Integration on a Storage System. This is a receiving and shipping system and/process/method for an autonomous mobile robot (quadra-pods, automated guided vehicles, ground-based pods, articulated robots, bipods, co-bots, humanoids, etc.), drones, and/or courier systems to deliver, hold, protect, and return parcels for multi-users in both residential and commercial applications. This is a system and process interlinking a receiving and shipping, smart receptacles with a communication system including package identifiers that enable a process to communicate location, contents, shipper, receiver and timing between the sender and receiver of the packages/parcels. The invention relates to drones, couriers, and/or autonomous mobile robots (AMR) for the delivery of parcels or goods. The present application relates to a process with a delivery location for receiving a package from a vehicle—drone or unmanned aerial vehicle (UAV), robotic carriers/couriers, or automated unmanned vehicle systems (AUVS) and AMRs. The present disclosure relates to communication and tracking system.

Arrive AI's “A” Project for The Villages is a pilot program designed to enhance secure and convenient package management for residents. At its core, the project introduces AI-powered Arrive Points, which serve as smart receiving and shipping centers, ensuring that deliveries are safe, organized, and accessible 24/7. These hubs act as intelligent package lockers, providing residents with a seamless way to receive and send out deliveries without the need to be home. Equipped with advanced RFID sensors, the system does more than just scan labels—it actively senses packages as couriers deliver them. The AI-powered hub gauges package size and directs couriers to the correct compartment, ensuring efficient space utilization. It then provides instant confirmation that the correct package has been secured in the right container, enhancing security and eliminating delivery errors. For residents shipping packages, the system includes an RFID printer, allowing them to simply bring a package to the hub and print its shipping label-no hassle, no fuss. This streamlined process makes sending out packages as easy as receiving them. By integrating advanced tracking, secure storage, and climate assist technology, the “A” Project aims to eliminate porch piracy, reduce missed deliveries, and simplify shipping needs for an active senior community.

There are many advantages for the system and process for A Touchless Processing System of Packages for Delivery and/or Pickup through Wireless Integration on a Storage System and Method for the Same. These include:
1. Uses RFID Technology and features for package tracking;
2. Maintains a chain of custody for packages/parcels;
3. New, small footprint combination;
4. Scale and size to needs of the client;
5. Add-ons to the system as needed;
6. Multiple delivery and Receiving stations; and
7. Can combine with conventional parcel systems.

The preferred embodiment of a Touchless Processing System of Packages for Delivery and/or Pickup through Wireless Integration on a Storage System and Method for the Same is: At a high level, Radio Frequency Identification (RFID) antennas coupled with RFID tags on packages allow the Touchless Processing System to establish a Chain of Custody on packages inferring intent and actions of package handlers (couriers, recipients, etc.) wherein a locker bank with antennas, screens, key pad, and connections are integrated with RFID components such as: A. RFID Antennas for Area, Mid and long range connectivity; B. RFID Antenna for presenting Short Range; C. RFID Antenna for compartments, short range; and D. RFID Tags on a package or RFID badge for identification on a person.

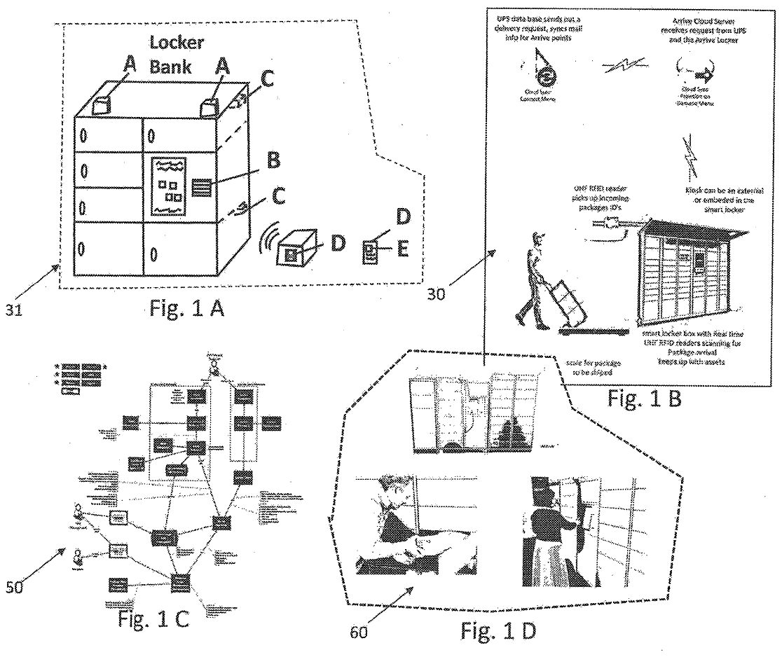

There is shown in FIGS. 1-5 a complete description and operative embodiment of a Touchless Processing System of Packages for Delivery and/or Pickup through Wireless Integration on a Storage System and Method for the Same. In the drawings and illustrations, one notes well that FIGS. 1-5 demonstrate the general configuration and use of this Touchless Processing System. The various example uses are in the operation and use section, below.

The accompanying drawings, which are incorporated in and constitute a part of this specification, illustrate an embodiment of the system and process for a Touchless Processing System. The drawings together with the summary description given above and a detailed description given below explain the principles of the system and process. It is understood, however, that the system and process of this Touchless Processing System is not limited to only the precise arrangements and instrumentalities shown. Other examples of package sending and receiving systems for drones, UAV/AMR, robotic carriers, and/or couriers are anticipated to be within the scope and spirit shown here.

FIGS. 1A through 1D are sketches of steps 60 in a Touchless Processing System 30 of Packages for Delivery and/or Pickup through Wireless Integration on a Storage System and Method for the Same, an overview/review of a real time RFID Smart Locker box 30 used for Postal companies that make use of RFID Labels, a flowchart 50 and discussion of the systems architecture, and sketches of a prototype 31 of the Touchless Processing System of Packages for Delivery and/or Pickup through Wireless Integration on a Storage System.

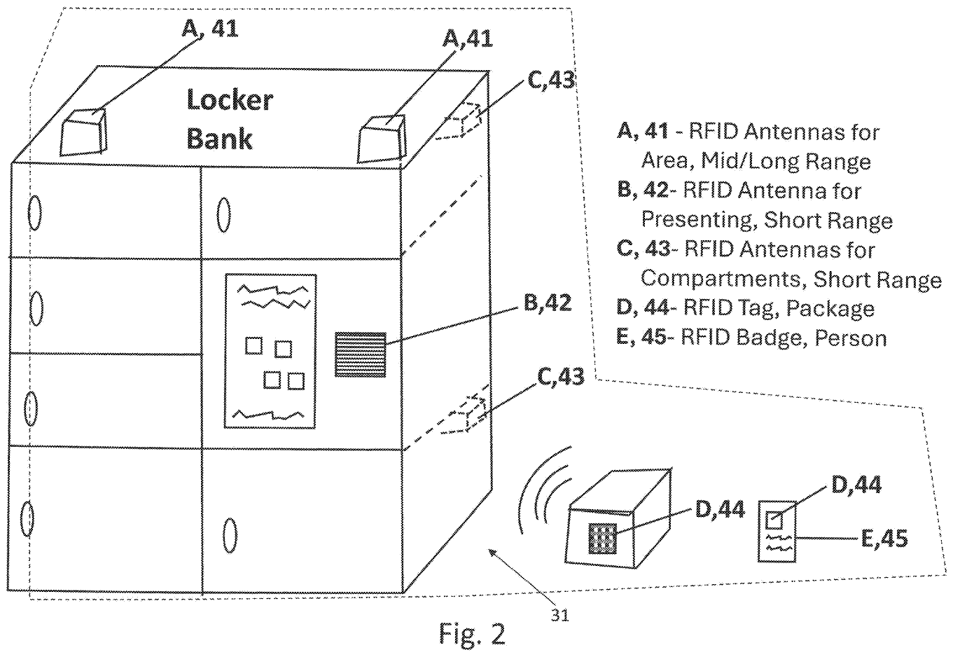

FIG. 2 is a working sketch of a prototype 40 of the Touchless Processing System 30 of Packages for Delivery and/or Pickup through Wireless Integration on a Storage System. Demonstrated here are: a Touchless Processing System 30 of Packages for Delivery and/or Pickup through Wireless Integration on a Storage System and Method for the Same; a set of components for the locker bank 31 and prototype; RFID Antennas 41 for Area, Mid/Long Range; RFID Antenna 42 for Presenting, Short Range; RFID Antennas 43 for Compartments, Short Range; RFID Tag 44, Package 150; and a RFID Badge 45 for a Person 100. One can observe that RFID and Blockchain technologies are utilized. At a high level, RFID antennas coupled with RFID tags on packages allow establishing a Chain of Custody on packages inferring intent and actions of package handlers (couriers, recipients, etc.). As shown are a locker bank with antennas, screens, keypad, and connections with the RFID components such as:
A. RFID Antennas for Area, Mid and long-range connectivity;
B. RFID Antenna for presenting Short Range;
C. RFID Antenna for compartments, short range;
D. RFID Tags on a package; and/or
E. RFID badge for identification on a person.
I. Area Antennas enable (through ID, signal strength, Phase): Identification of packages in an Area (ID, Signal strength) Arrival and departure;
   Identification of a Delivery Courier based on Packages, Arrival, Departures;
   Position of packages in an Area; and
   Detection of packages movement/moving toward locker and disappearing into locker.
II. Presenting Antennas enable: Detecting package presented for deposit into locker ID presented for Identification of User.
III. Compartment antennas enable Matching Locker location to package.

Process and System for Wireless and Touchless Processing of Packages for Delivery or Pickup in a Storage Device (from an example Document Version: 2/13/2025).

### System Includes

1. A human or robotic device capable of transporting packages to and/or from the storage device.
2. Packages including an active or passive electronic tag (e.g. an RFID tag) that can receive and transmit data with a remote device, data may include identification, transactional history, condition of package, history of condition of package, chain of custody records, etc.
3. A storage device with one or more storage locations where packages can be placed. Storage locations may be secured with a locking door.
4. A set of antennas mounted in and/or around the storage device configured to be able to interact and exchange data with the tags included on the packages. Locations and types of antennas may include:
   a) Long-range antenna(s) configured to be able to interact with packages at some distance from the storage device.
   b) Mid-range antenna(s) configured to be able to interact with packages next to the storage device.
   c) Short-range antenna(s) configured to be able to interact with packages presented to a panel intended for user interaction.
   d) Short-range antenna(s) configured to be able to interact with packages inside each storage location. This may be realized by having one antenna inside every storage location.
5. One or more radio devices connected to the antenna(s) such that data about the package tags can be read and/or written. This may include data from the tags themselves or it may include information about the physical state of the tags (e.g. location, direction, direction of motion, distance, speed, etc.).
6. A computing device that interacts with the radio devices, records information, and makes decisions about how the storage device should behave. It can also be connected to the internet or other remote computing and data resources. It can interact with users through visual or audio prompts, receiving touch or verbal feedback in return. It can attach cameras on the storage device to enable it to record images or video. It can include the ability to run AI models to interact with the users and interpret the intent of words and actions, also providing appropriate feedback and instruction.

### Sample of a System Process

1. A delivery driver approaches a bank of lockers (the “storage device”) with an armload of packages, each including am RFID tag with a unique identifier.
2. A radio device built into the bank uses a long-range antenna to detect the approach of the packages. It checks those packages against packages that are expected to be received.
3. Assuming they match, the bank recognizes that a valid delivery is under way and automatically starts the process of receiving those packages into the lockers. If additional security is required, the delivery driver may also carry a personal tag that the system can recognize. If even further security is required, the delivery driver can be required to enter a PIN number or provide some other form of multi-factor authentication.
4. The driver presents a package to a short-range antenna positioned near a video screen giving instructions.
5. The bank recognizes the package presented and decides about which locker to open to receive the package. This decision could be based on already known information or it could be based on additional devices that can estimate the size of the package based on image sensors and/or 3D point cloud sensors.
6. The driver moves toward the open locker. Through a mid-range antenna. The bank may see the motion of the package and verify that it is on its way to be placed into a locker.
7. Once the package is placed in the locker and the door is closed, the bank verifies that it has been placed in the locker. This can be done through either a short-range antenna within the locker itself or through the mid-range antennas detecting that the package can no longer be seen (assuming the locker door blocks the signal) or detecting that it is no longer moving.
8. This process repeats for multiple packages. Alternatively, in the interest of efficiency, it may be desirable for the bank to open multiple lockers simultaneously and the driver chooses where to place each package. In this case the antennas will be used to determine which package went where (like the process for a single package described above).
9. The bank may be able to detect if the driver is having trouble with a package based on movement and interpretation of video data. In that case, it may offer assistance like providing a larger locker.
10. After the packages have been delivered, the bank sends a signal so that the intended recipients are notified and given an access method to pick up their packages.
11. After a recipient arrives and is authenticated (with records and images kept for chain of custody), the locker(s) with their package(s) is opened.
12. Through the same antennas used to detect where the package was placed, the bank detects when the recipient has removed their package and that the correct package was removed.

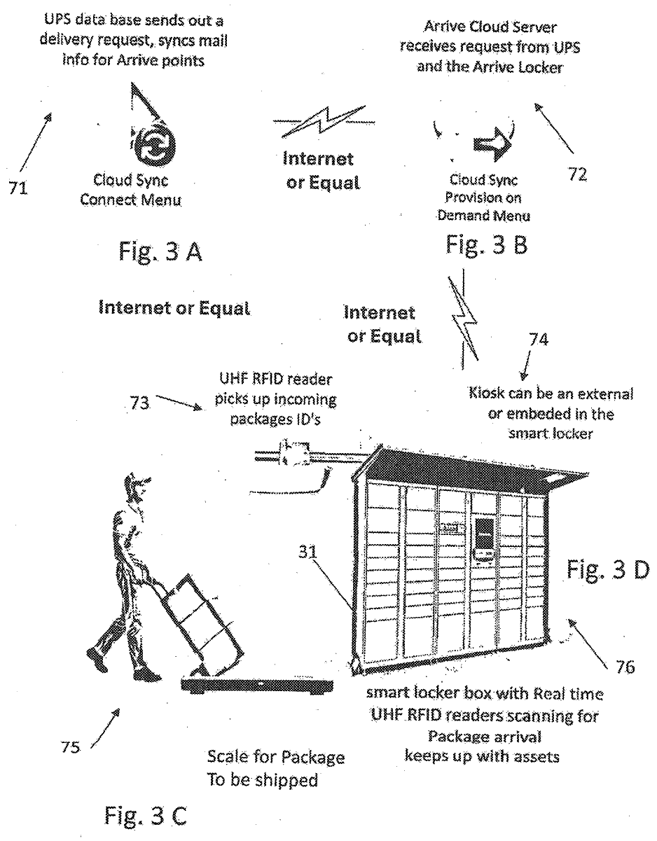

FIGS. 3A through 3D are sketches of a Touchless Processing System 30 of Packages for Delivery and/or Pickup through Wireless Integration on a Storage System and Method for the Same. Presented here are a Touchless Processing System 30 of Packages for Delivery and/or Pickup through Wireless Integration on a Storage System and Method for the Same; the features 70 of a Touchless Processing System 30 of Packages for Delivery and/or Pickup through Wireless Integration on a Storage System and Method for the Same; a feature 71 UPS data Base sends out a delivery request, synchs mail info for Arrive Points; a feature 72 Arrive Cloud server receives request from UPS and the Arrive locker 31; a feature 73 UHF RFID reader picks up/receives incoming packages 150 IDs; a feature 74 Kiosk can be external or embedded in the smart box/locker 31; a feature 75 scale for packages 150 to be shipped; a feature 76 smart locker box 76, 31 with real time UHF RFID Readers scanning for Package 150 arrival keeps up with assets; a Person 100; and a Package 150. Here, FIG. 3A shows a UPS/Fed Ex, DHL or common carriers database sends out a delivery request, syncs mail info for Arrive points. It is a Cloud Sync Connect Menu and interconnected by Internet or Equal. FIG. 3B Arrive Cloud Server receives a request from UPS/Fed Ex, DHL or common carriers and Arrive Locker Cloud Sync Provisions on Demand Menu. FIG. 3C Scale for package to be shipped. FIG. 3D UHF RFID reader picks up incoming packages ID's. The Kiosk can be external or embedded in the smart locker Smart Locker box with the Real Time UHF RFID (UHF-Ultra High Frequency) RFID (Radio-Frequency Identification) readers scanning for Package arrival keeps up with assets.

For a real time RFID Smart Locker box used for Postal companies that make use of RFID Labels, consider the following: Introduction:

This is a discussion about Project “A”. Arrive AI is in discussions about future technologies that can make the company a success. The project is taken very seriously. While the team was brainstorming, several discussed system reliability. Research showed that the Impinj R700 series Rain RFID, is an exceptional technology and a good solution for this project because it allows one to build a smart Locker box that can track the contents. When a courier brings packages and puts them into the box, the smart box will always know where it is, and which door it is behind. Small antennas in each door box, saves time when a Delivery person with the packages can be automatically identified. For example, the Delivery person brings up five packages to the smart locker, the packages will be picked up by the RFID readers that is outside the smart Locker box. Those IDs then are compared to the database which is in the cloud server that synchronizes the Kiosk, when matched the doors will open. A delivery notification will be sent via text and/or email containing data regarding package size and person to whom the package is addressed. While this is happening in real time, one does not need to keep track of where a package is within the smart locker. This RFID system will be faster and more efficient because the smart locker is able to do real-time asset tracking.

### Courier Delivery:

The Smart Locker includes a Kiosk and package pad on site. A delivery courier will have multiple packages to deliver to the smart lockers. As the courier gets within close range the RFID readers will automatically open the appropriate number of doors to receive each package. If there is a package that does not go to this locker the kiosk will verbally alert and say and display the packages that need to be put aside. Once all the packages are loaded into the smart locker, they will be read Individually by RFID readers that is in each door then store package location to the cloud, and that information will be sent to the customer by Email, Text using SMS.

### Customer Pickup:

Once the customer receives the email or SMS, he or she can pick up the package by walking up to the Kiosk and presenting their personal RFID card along with a pin code that identifies that person. The customer will have options when they approach the screen. If they select pick-up, a door with their packages will automatically open and this can be multiple doors, if they have a lot of deliveries.

### Customer Return to Sender:

When the customer gets a package and for some reason they want to return it to sender, they would walk up to the Kiosk and present their personal RFID card alone with a pin code that identifies that person. They can touch the screen and select return package to sender. A message letting them know a new package label will be printed, once that label is printed, they would place it next to the original label and place it back on the pad. The RFID's will be read and send to the Courier the new label data that is Associated with the box that was originally delivered

### Customer Shipping a New Package:

From home the customer sets up an account with the Courier and pays for the package, selects Shipping using an Arrive Smart Locker. Once they arrive at our smart locker, they set the package on the pad which will weigh. It will make the appropriate adjustments to the weight and display it on the kiosk along with actual cost. Once accepted, the Shipping Label will be created, the customer then will place it back on the pad where it will recheck the weight and newly created label, data will be updated and sent to our cloud and the courier will be sent the package information, then a door on the Arrive Smart Locker box will be opened, the customer will place it in the box and shut the door. That will conclude the transaction.

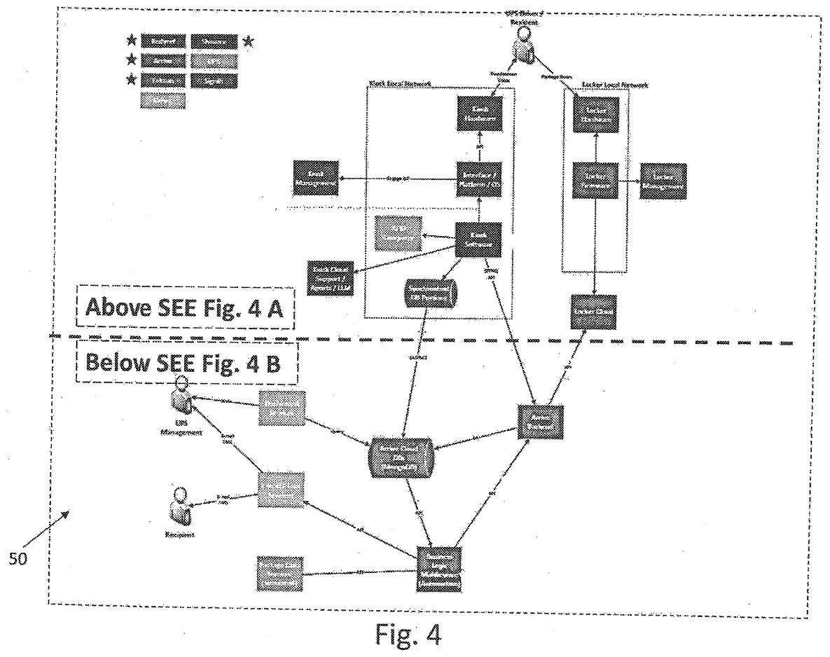

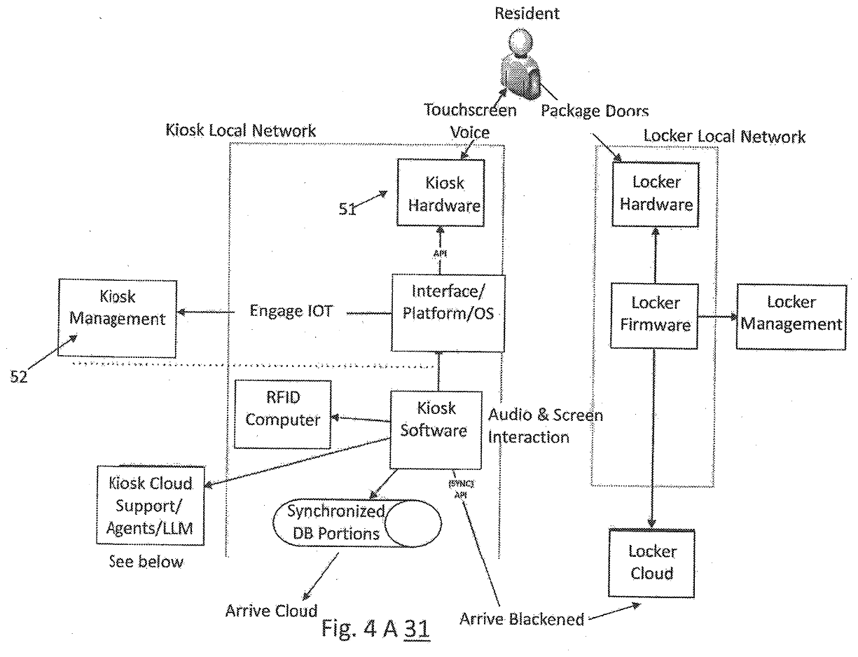

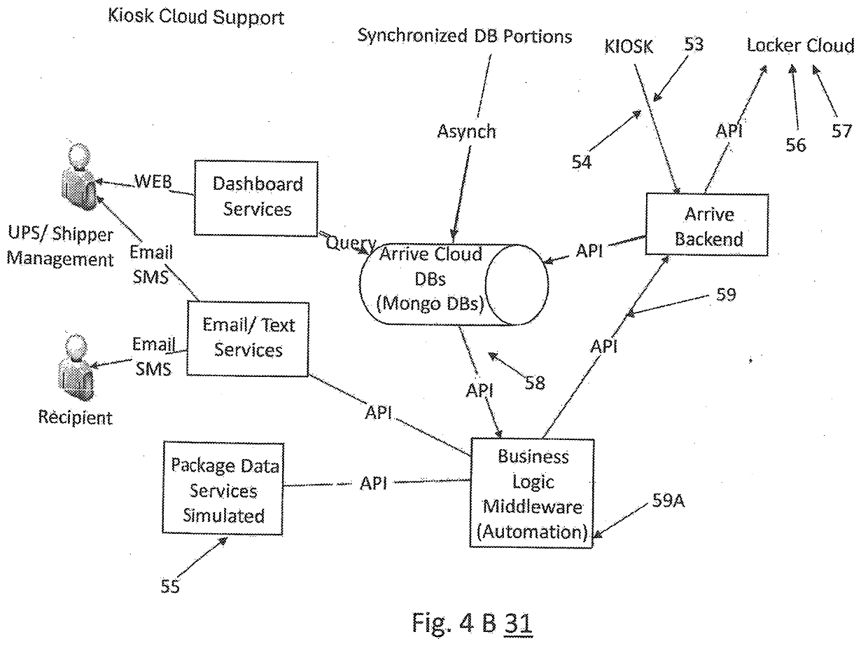

FIGS. 4, 4A and 4B are a flowchart 50 and discussion of the systems architecture and communication of the Touchless Processing System of Packages for Delivery and/or Pickup through Wireless Integration on a Storage System. Portrayed and explained here are: a flowchart 50 and discussion of the systems architecture; a flow chart feature 51—Kiosk hardware Screen, Microphone, Speaker, Barcode Reader, and Camera Communications; a flow chart feature 52 Key Functionality SW to Hardware, Read RFID, Read Barcode; a flow chart feature 53 Key Functionality—Kiosk to Cloud—notify of Outbound Shipment, Request Package Compartment for Outbound, Events include Request Package Data and Request Locker Door Open;
a flow chart feature 54 Key Functionality—Cloud to Kiosk—Notify of Inbound Shipment, ACL Management, Share Locker Reservations List; a flow chart feature 55 Key Functionality—Direction—Package Delivery Plan (to Arrive) and Package Size Validations(UPS); a flow chart feature 56 Key Functionality—Locker to Cloud—Status Updates(Health, Doors, Compartments)and Events (Door Open/Close, Compartment Change); a flow chart feature 57 Key Functionality—Cloud to Locker—Open Each Locker, Read Open/Closed Status for Each Locker, Get List of Lockers, Get Logs, (Open all Lockers) and (Operational Status); a flow chart feature 58 Key Functionality—DB to Middleware Change Events; a flow chart feature 59 Key Functionality—Middleware to Backend—DB Updates, DB Reads, Atomic Locker Actions; and a flow chart feature 59A Key Functionality—Business Logic—Compartment Reservations, Compartment Access, and Notifications. Consider with the architecture and flow chart shown in the FIGS. 4, 4A and 4B, the following overview: This narrative is based on Phase 1 demo proposal. It does not include shipping or in-locker RFID detection.

### Courier Delivery

### Pre-Delivery

1. Arrive Cloud receives from UPS/Fed Ex, DHL or common carriers a manifest of all packages that will be delivered to the Locker Bank. The manifest data will look something like the below.

```
“courier_identity”: “JSA1253”,
“locker_address”: {...},
“expected_arrival_start”: “11/11/2024 0800”,
“expected_arrival_end”: “11/11/2024 1200”,
“packages”: [
  “tracking_number”: “1Z3595032750327”,
  “rfid_tag”: “1453970537207530”,
  “destination_address”: [...],
  “dimensions”: [...],
  “weight”: “10lbs
```

2. Arrive Cloud reviews all packages and confirms that it can reserve space for them in the Locker Bank.
3. Arrive Cloud reviews all packages and confirms that the destination address is tied to a valid/known recipient (for purposes of notification).
4. Arrive Cloud returns accept/reject messages are returned to UPS/Fed Ex, DHL or common carriers for each package.
5. Arrive Cloud stores a Package database record with the package information, like identifiers, dimensions, weight, and recipient.
6. Arrive Cloud stores a Reservation database with information about where the package should be stored. If the package is not accepted, probably it still has a reservation record, but the assigned Locker ID is “n/a” (or similar).
7. Kiosk synchronizes a local copy of the Packages and Reservation database for its location.

### Driver Delivery

8. Driver approaches Locker Bank with some/all packages from the assigned delivery.
9. Kiosk detects approaching RFID tags from packages (with long-distance RFID antenna) and checks them against local Reservation database.
10. If any RFID matches the Reservation list (per Kiosk), then Driver is authenticated.
11. Driver is prompted to begin delivery (with visual and maybe audible instructions on how to do so). To start the delivery process, they can give a verbal response, touchscreen response, or “present” the first package at the short-distance RFID antenna. At this point, the delivery process starts (logged along with a captured image).
12. Driver “presents” Locker Bank with one package at a time.
13. Kiosk recognizes RFID of package and sends API request to Arrive Cloud to open Locker specified in Reservation.
14. Arrive Cloud sends request to Locker Cloud to open Locker.
15. Locker Cloud opens Locker.
16. Driver puts package in Locker and closes door.
17. Locker Cloud notifies Arrive Cloud of Locker closing.
18. Arrive Cloud notifies Kiosk of Locker closing.
19. Kiosk will notify driver if Locker has been left open.
20. Kiosk updates Package and Reservation status for package.
21. Kiosk repeats steps until one of the following:
   a. All packages in Reservation received.
   b. Driver terminates entire delivery.
   c. Timeout.
   d. Senses driver has left (by Driver RFID tag).
22. Kiosk notifies Driver that delivery is complete. If pick-ups are present in locker bank, prompt Driver to accept, then follow Driver Pick-Up process and continue this one.
23. Kiosk notifies Arrive Cloud of end of Delivery.
24. Kiosk synchronizes a local copy of the Packages and Reservation database for its location.
25. Arrive Cloud creates Access Control record for each Recipient with Packages in the Locker Bank. Each package will have a unique authentication method.
26. Arrive Cloud notifies Recipient with Locker Bank information and authentication method (SMS and/or e-mail).
27. Kiosk synchronizes a local copy of the Access Control database for its location.

### Resident Pick-Up (1 QR/PIN Per Package)

1. Recipient approaches Locker Bank with proper authentication credentials (likely PIN and/or QR code).
2. Kiosk interacts with Recipient and validates authentication credentials against local Access Control database.
3. Kiosk sends request to Arrive Cloud to open Locker specified in Access Control database.
4. Arrive Cloud sends request to Locker Cloud to open Locker.
5. Locker Cloud opens Locker.
6. Recipient retrieves package from Locker and closes door.
7. Locker Cloud notifies Arrive Cloud of Locker closing.
8. Arrive Cloud notifies Kiosk of Locker closing.
9. Kiosk updates Package and Reservation status.
10. Kiosk synchronizes a local copy of the Packages and Reservation database for its location.
11. Arrive Cloud notifies Recipient of package pick up.
12. Arrive Cloud notifies UPS/Fed Ex, DHL or common carriers of package pick up.

### Post-Driver Delivery

On a regular schedule, Arrive Cloud sweeps through list of packages still in each Locker Bank. If package has been there longer than a certain period, a reminder notification is sent to the Recipient. If package is there even longer, then a recall message is sent to UPS/Fed Ex, DHL or common carriers.

### Resident Drop-Off of UPS/Fed Ex, DHL or Common Carriers Package (Assume No RFID)

Assume each package will be scanned individually and 1:1 package to locker relationship.
1. Resident selects “Drop Off Package” on the Kiosk touchscreen or says out aloud “Hey Project A” I want to drop off my package”.
2. Kiosk prompts to scan tracking number on package label.
3. Resident scans the package tracking number using the kiosk barcode scanner.
4.Kiosk asks Resident which size locker will be appropriate.
5.Kiosk sends tracking number and locker size to Arrive Cloud for verification.
6. Arrive Cloud verifies tracking number.
7. Arrive Cloud creates entries in Packages and Reservations databases.
8.Arrive Cloud returns validity and locker assignment.
9.Kiosk shows locker assignment to Resident.
10. Kiosk sends request to Arrive Cloud to open specified Locker.
11. Arrive Cloud sends request to Locker Cloud to open Locker.
12. Locker Cloud opens Locker.
13. Kiosk emits beeping sound and flashing light when Locker is opened. Nothing further can happen until Locker is closed.
14. Resident puts package in Locker and closes door.
15. Locker Cloud notifies Arrive Cloud of Locker closing.
16. Arrive Cloud notifies Kiosk of Locker closing.
17. Kiosk stops beeping and flashing.
18. Kiosk updates Package and Reservation status.
19. Kiosk displays screen confirming package deposit.

### Driver Pick-Up of UPS/Fed Ex, DHL or Common Carriers Package (not Part of Drop Off)

### WIP

1. Driver selects “Pick Up Package” on the kiosk touchscreen or says out aloud “Hey “A” Project, I want to pick up packages”.
2. Kiosk checks if driver RFID tag is present (any antenna). If present, the Driver is authenticated.
3. Kiosk looks up in local Packages database which Packages have a status indicating ready for pick up by a Driver.
4. Kiosk looks up which Lockers contain the Packages for pick up.
5. Kiosk confirms authentication on screen
6. Kiosk states and presents on screen which Lockers have Packages to pick up.
7. Kiosk sends request to Arrive Cloud to open specified Locker(s).
8. Arrive Cloud sends request to Locker Cloud to open Locker(s).
9. Locker Cloud opens Locker.
10. System opens all locker doors at one time
11. System emits beeping sound and flashing light while all doors are open and driver is collecting packages
12. Driver collects each package and then ensures each locker door is closed
13. System stop emitting beeping sound and flashing light once all doors are closed securely
14. System confirms by voice and screen display that all packages have been collected and all door have been closed securely.

### Overarching Features/Functions

Failsafe for Drivers and Recipients to drop off and pick up packages (no RFID for Driver, do not remember PIN for Recipients)
Camera video monitoring interactions with kiosk and lockers (does not need to be integrated)
Set up database of Recipients (can be manual entry for initial demos)
Ability to “reset” system for demo purposes so that manifests and packages can be re-used.

### Parking Lot

Be able to request re-send of authentication information by Recipient at Kiosk.
Higher security deliveries, age or identity verification.
Reliability analysis of parts of system from logs.
What do we do if a door is left open for an extended period of time? Either with or without a package?
How to work with Resident for making a drop off if package does not fit.
Resident receives a confirmation receipt (printed, emailed, or via UPS/Fed Ex, DHL or common carriers app).
Notification of last pick up status for drop off for outbound shipping.
What to do when different pick up drivers for different services?

### RFID Pre-Processor Messaging

The purpose of the RFID Pre-Processor is to handle the load of the real-time stream of tag readings from a long-range and a short-range antenna, and to interpret the movement of packages. The goal is to determine when a load of packages has arrived in the area and then to deduce when the driver has selected a particular package to store in the locker. The Pre-Processor does this by receiving a manifest of tag numbers, scanning for those tags that come into the view of the two antennas, and reporting back which ones have been seen. When a tag in the manifest meets the criteria for being “presented” to the short-range antenna, the Pre-Processor sends a message reporting that one tag.
The RFID Pre-Processor will communicate with MQTT messaging on a Mosquitto broker at 127.0.0.1:1883.

### Sending the Manifest

The manifest is sent to the RFID Pre-processor using the MQTT topic “tag/manifest”, QoS 1, and the following example JSON message:

```
  “tagList”: [
    “1A0011606000021209B24CE2”, // 24-character
hexadecimal EPC
    “1A001308480B53066B641FDF”,
    “1A00C312F6AC34740C80097B”,
    “1A000F76B98093058C714637”,
    “1A00E5D50FDBEA37B622249E”
```

The key “tagList” is followed by a variable-length array of EPC numbers. The array may be empty in cases where the manifest needs to be cleared.

### Tags in View

When the Pre-processor has a manifest, it begins to scan for the listed tags. If it finds one or more, it begins sending a variable-length message with the MQTT topic “tag/inView”, QoS 0, and the following example JSON message:

```
  ″tagList″: [
    { ″epc″: ″1A0011606000021209B24CE2″, ″lastSeen″:
“2024-12-03T21:42:19.393496308Z”},
    { ″epc″: ″1A001308480B53066B641FDF″, ″lastSeen″:
″: “2024-12-03T21:42:20.839363049Z”},
    { ″epc″: ″1A00C312F6AC34740C80097B″, ″lastSeen″:
″: “2024-12-03T21:42:17.936308349Z”
```

The “tag/inView” message will run once a second until the Pre-processor receives a new manifest or an empty manifest through the “tag/manifest” message. If the Pre-processor receives a new manifest, it will immediately begin looking for tags in the new manifest. This means that the main process can effectively acknowledge a tag by sending a manifest that contains all the prior tags except for the one being acknowledged. This way, the main process always knows the manifest that the Pre-processor is using.

### Tag Being Presented

When the driver intends to put a package in the locker, he moves it by itself toward and close to the short-range antenna. The Pre-processor deduces this movement and sends the main process a message using the MQTT topic “tag/presented”, QoS 1, and the following example JSON message:
“epc”: “1A00E5D50FDBEA37B622249E”,
“lastSeen”: “2024-12-03T21:42:17.936308349Z”
   Only tags that are in the manifest can be reported as “presented.” Once a tag is reported as having been presented, it is quarantined for [to be determined, presently 5] seconds before it can meet the criteria again. This will prevent repeated nuisance messages and provide time for the main process to remove the tag from the manifest.
   Driver In View When the driver is in view of either of the antennas, the Pre-processor sends the main process a message using the MQTT topic “tag/driver”, QoS 1, and the following example JSON message:
“epc”: “1B00E5D50FDBEA37B622249E”,
“lastSeen”: “2024-12-03T21:42:17.936308349Z”
   The driver tags are not listed in the manifest. Once a driver tag is reported as being in view, it is quarantined for [to be determined, presently 15] seconds before it is sent again.

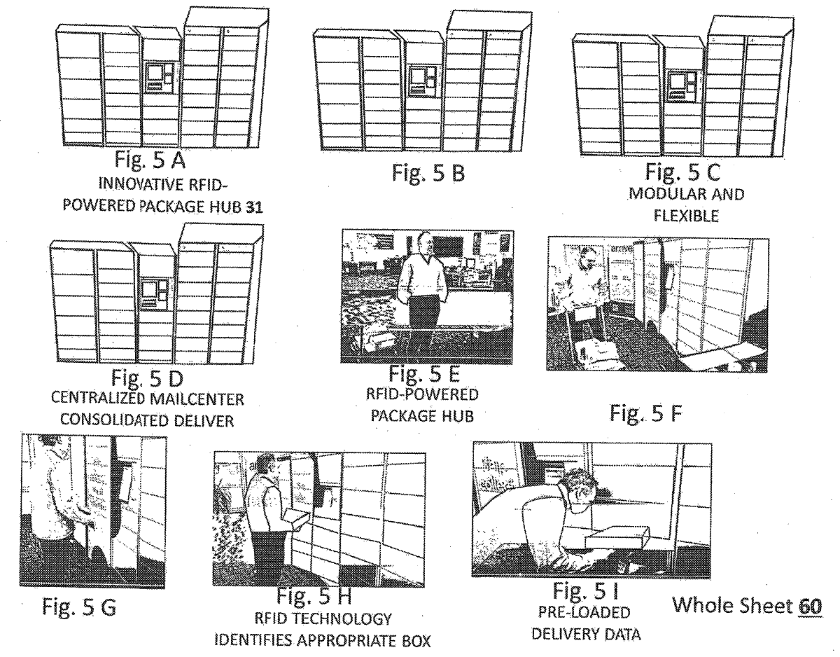

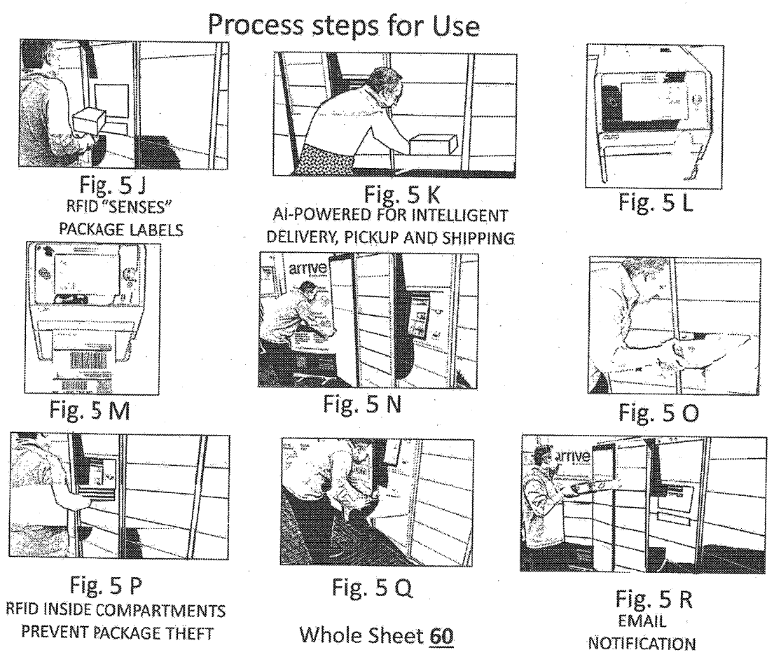

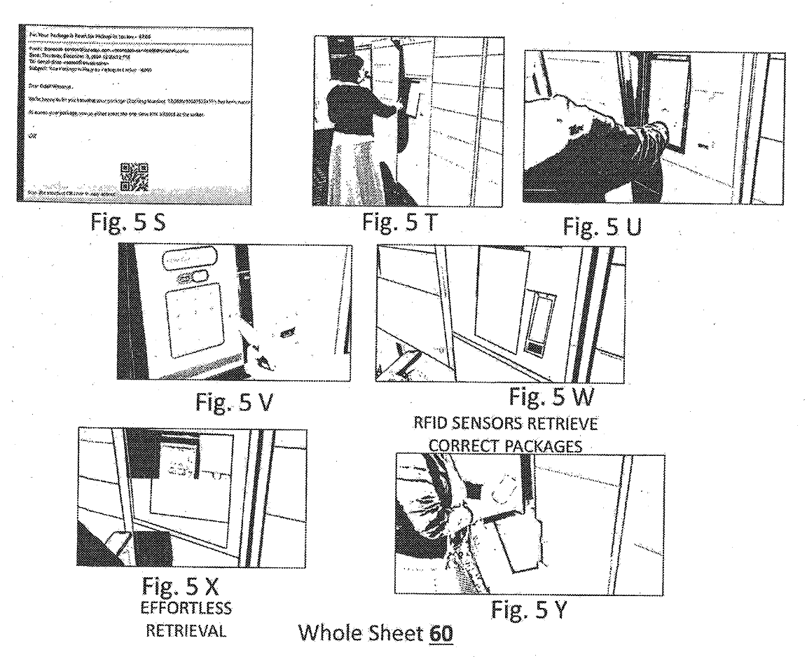

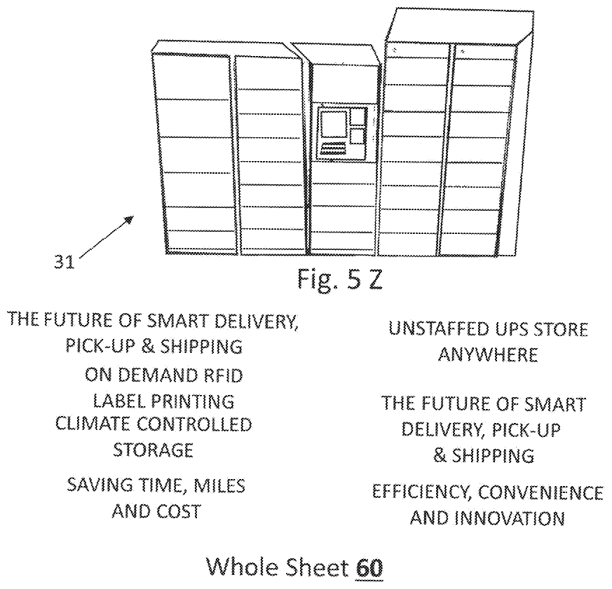

FIGS. 5A through 5Z are sketches of steps 60 in a Touchless Processing System 30 and the operation of a prototype system of the Touchless Processing System of Packages for Delivery and/or Pickup through Wireless Integration on a Storage System. These are described in the Operations section below.

### OPERATION OF THE PREFERRED EMBODIMENT

Shown above is a Touchless Processing System of Packages for Delivery and/or Pickup through Wireless Integration on a Storage System and Method for the Same. The preferred embodiment of a Touchless Processing System of Packages for Delivery and/or Pickup through Wireless Integration on a Storage System and Method for the Same is: At a high level, Radio Frequency Identification (RFID) antennas coupled with RFID tags on packages allow the Touchless Processing System to establish a Chain of Custody on packages inferring intent and actions of package handlers (couriers, recipients, etc.) wherein a locker bank with antennas, screens, key pad, and connections are integrated with RFID components such as: A. RFID Antennas for Area, Mid and long range connectivity; B. RFID Antenna for presenting Short Range; C. RFID Antenna for compartments, short range; and D. RFID Tags on a package or RFID badge for identification on a person.

FIGS. 5A through 5Z are sketches of steps 60 in a Touchless Processing System 30 and the operation of a prototype system of the Touchless Processing System of Packages for Delivery and/or Pickup through Wireless Integration on a Storage System. Thes various sketches are supported by the following description of the operation:
A Introducing the Arrive Point, an innovative RFID powered package hub designed to revolutionize smart delivery, pickup and shipping.
B Modular and flexible, these hubs can be placed anywhere, providing a seamless solution for centralized mail centers and consolidated delivery stops.
C Here's how it works.
D When a driver arrives, the Arrive Point's RFID system reads and authorizes their ID, instantly verifying the delivery details for each package.
E The system identifies the size and destination of each package, assigning it to the appropriate compartment.
F This process is powered by preloaded delivery data, making drop offs efficient and accurate.
G Advanced technology allows the arrive point to not simply read the package labels, it senses them.
H Powered by AI, users enjoy an enhanced experience with intelligent package delivery, pickup, and shipping.
I Place the package for 0329.
J Clean clothes in a locker 4198 four 1190.
K I know what it is doing.
L Place the package for 25034 Bernhard threw away in the locker.
M Once the package is inside the compartment and the door is secured, RFID inside each box gives a final confirmation that the package was placed and secured inside the appropriate compartment.
N At this point, the package is tendered to the consignee and an e-mail is immediately triggered notifying that the package is ready for pickup with the supplied unique access code.
O Thank you for delivering that package.
P Now the customer experience.
Q OK, I am retrieving now.
R I think I want to pick up my package.
S OK, I am here to get my package.
T With just a few taps on the display, the consignee enters their unique code.
U RFID sensors ensure the correct package is retrieved, providing a secure and effortless experience
V The entire process is completed in seconds.
W The Arrive Point is future ready, capable of integrating features like on demand shipping, label printing plus climate-controlled compartments ensure sensitive packages are stored in optimal conditions.
X By consolidating stops, the Arrive Point saves time, reduces miles and cuts costs, aligning perfectly with UPS/Fed Ex, DHL or common carrier systems.
Y Think of it as an unstaffed UPS/Fed Ex, DHL or common carriers store that can be deployed anywhere, faster and more affordably than a traditional brick and mortar location.
Experience the future of smart delivery, pickup, and shipping, proving every day that. efficiency, convenience, and innovation can work together seamlessly.

With this description it is to be understood that a Touchless Processing System of Packages for Delivery and/or Pickup through Wireless Integration on a Storage System and Method for the Same is not to be limited to only the disclosed embodiment of product. The features of the device and system are intended to cover various modifications and equivalent arrangements included within the spirit and scope of the description.

While certain novel features of this invention have been shown and described and are pointed out in the annexed claims, it is not intended to be limited to the details above, since it will be understood that various omissions, modifications, substitutions and changes in the forms and details of the device illustrated and in its operation can be made by those skilled in the art without departing in any way from the spirit of the present invention. Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

Unless defined otherwise, all technical and scientific terms used herein have the same meaning as commonly understood by one of ordinary skill in the art to which these inventions belong. Although any methods and materials similar or equivalent to those described herein can also be used in the practice or testing of the present inventions, the preferred methods and materials are now described above in the foregoing paragraphs.

Other embodiments of the invention are possible. Although the description above contains much specificity, these should not be construed as limiting the scope of the invention, but as merely providing illustrations of some of the presently preferred embodiments of this invention. It is also contemplated that various combinations or sub-combinations of the specific features and aspects of the embodiments may be made and still fall within the scope of the inventions. Various features and aspects of the disclosed embodiments can be combined with or substituted for one another to form varying modes of the disclosed inventions. Thus, it is intended that the scope of at least some of the present inventions herein disclosed should not be limited by the particular disclosed embodiments described above.

The terms recited in the claims should be given their ordinary and customary meaning as determined by reference to relevant entries (e.g., definition of “plane” as a carpenter's tool would not be relevant to the use of the term “plane” when used to refer to an airplane, etc.) in dictionaries (e.g., widely used general reference dictionaries and/or relevant technical dictionaries), commonly understood meanings by those in the art, etc., with the understanding that the broadest meaning imparted by any one or combination of these sources should be given to the claim terms (e.g., two or more relevant dictionary entries should be combined to provide the broadest meaning of the combination of entries, etc.) subject only to the following exceptions: (a) if a term is used herein in a manner more expansive than its ordinary and customary meaning, the term should be given its ordinary and customary meaning plus the additional expansive meaning, or (b) if a term has been explicitly defined to have a different meaning by reciting the term followed by the phrase “as used herein shall mean” or similar language (e.g., “herein this term means,” “as defined herein,” “for the purposes of this disclosure [the term] shall mean,” etc.). References to specific examples, use of “i.e.,” use of the word “invention,” etc., are not meant to invoke exception (b) or otherwise restrict the scope of the recited claim terms. Other than situations where exception (b) applies, nothing contained herein should be considered a disclaimer or disavowal of claim scope. Accordingly, the subject matter recited in the claims is not coextensive with and should not be interpreted to be coextensive with any particular embodiment, feature, or combination of features shown herein. This is true even if only a single embodiment of the particular feature or combination of features is illustrated and described herein. Thus, the appended claims should be read to be given their broadest interpretation in view of the prior art and the ordinary meaning of the claim terms.

Unless otherwise indicated, all numbers or expressions, such as those expressing dimensions, physical characteristics, etc. used in the specification (other than the claims) are understood as modified in all instances by the term “approximately.” At the very least, and not as an attempt to limit the application of the doctrine of equivalents to the claims, each numerical parameter recited in the specification or claims which is modified by the term “approximately” should at least be construed in light of the number of recited significant digits and by applying ordinary rounding techniques.

The present invention contemplates modifications as would occur to those skilled in the art. While the disclosure has been illustrated and described in detail in the figures and the foregoing description, the same is to be considered as illustrative and not restrictive in character, it being understood that only selected embodiments have been shown and described and that all changes, modifications and equivalents that come within the spirit of the disclosures described heretofore and or/defined by the following claims are desired to be protected.

What is claimed is:

1. A touchless processing system for packages for delivery and/or pickup, comprising: a storage device having at least one lockable compartment; at least one RFID tag affixed to each package, the RFID tag storing identification, chain-of-custody, and condition data; a plurality of RFID antennas mounted on or around the storage device, the antennas including: (a) at least one long-range antenna configured to detect packages approaching the storage device; (b) at least one mid-range antenna configured to track package movement adjacent the storage device; (c) at least one short-range presenting antenna positioned at a user-interface panel; and (d) at least one short-range compartment antenna located inside each lockable compartment; one or more RFID readers coupled to the antennas and configured to read from and write to the RFID tags; a computing device in communication with the RFID readers, the computing device controlling the lockable compartments and connected to a remote cloud server; and a user interface coupled to the computing device, the user interface comprising a touchscreen, microphone, speaker, camera, and barcode scanner.

2. The system of claim 1, further comprising cloud middleware that performs automatic compartment reservation based on package dimensions obtained from pre-delivery manifest data and real-time scale or image measurements.

3. The system of claim 1, wherein the computing device and cloud middleware maintain a real-time chain-of-custody record by timestamping every RFID read event, door actuation, and user authentication.

4. The system of claim 1, wherein the RFID tags and antennas enable detection of package movement direction, speed, and disappearance into a specific compartment, thereby confirming proper placement without line-of-sight or manual scanning.

5. A method of touchless package processing using the system of claim 1, the method comprising the steps of: (a) detecting, via the long-range antenna, an approaching RFID-tagged package listed in a pre-loaded manifest; (b) authenticating the carrier and presenting the package to the short-range presenting antenna; (c) automatically opening an appropriately sized compartment; (d) verifying placement of the package inside the compartment using the compartment antenna; (e) closing and locking the compartment and updating the chain-of-custody record in the cloud; and (f) transmitting a pickup notification to the intended recipient with an authentication credential.

6. The method of claim 5, further comprising the outbound shipping steps of: receiving a customer request at the kiosk, printing an RFID-enabled shipping label, weighing the package, assigning a compartment, and notifying a carrier for pickup.

7. A Touchless System Process for Packages for Delivery and/or Pickup through Wireless Integration on a Storage System and Method for the Same comprising:
Step 1: A delivery driver approaches a bank of lockers (the “storage device”) with an armload of packages, each including am RFID tag with a unique identifier.
Step 2: A radio device built into the bank uses a long-range antenna to detect the approach of the packages. It checks those packages against packages that are expected to be received.
Step 3: Assuming they match, the bank recognizes that a valid delivery is under way and automatically starts the process of receiving those packages into the lockers. If additional security is required, the delivery driver may also carry a personal tag that the system can recognize. If even further security is required, the delivery driver can be required to enter a PIN number or provide some other form of multi-factor authentication.
Step 4: The driver presents a package to a short-range antenna positioned near a video screen giving instructions.
Step 5: The bank recognizes the package presented and decides about which locker to open to receive the package. This decision could be based on already known information or it could be based on additional devices that can estimate the size of the package based on image sensors and/or 3D point cloud sensors.
Step 6: The driver moves toward the open locker. Through a mid-range antenna. The bank may see the motion of the package and verify that it is on its way to be placed into a locker.
Step 7: Once the package is placed in the locker and the door is closed, the bank verifies that it has been placed in the locker. This can be done through either a short-range antenna within the locker itself or through the mid-range antennas detecting that the package can no longer be seen (assuming the locker door blocks the signal) or detecting that it is no longer moving.
Step 8: This process repeats for multiple packages. Alternatively, in the interest of efficiency, it may be desirable for the bank to open multiple lockers simultaneously and the driver chooses where to place each package. In this case the antennas will be used to determine which package went where (like the process for a single package described above).
Step 9: The bank may be able to detect if the driver is having trouble with a package based on movement and interpretation of video data. In that case, it may offer assistance like providing a larger locker.
Step 10: After the packages have been delivered, the bank sends a signal so that the intended recipients are notified and given an access method to pick up their packages.
Step 11: After a recipient arrives and is authenticated (with records and images kept for chain of custody), the locker(s) with their package(s) is opened.
Step 12: Through the same antennas used to detect where the package was placed, the bank detects when the recipient has removed their package and that the correct package was removed.
